(19) United States
(12) Patent Application Publication
(10) Pub. No.: US 2014/0029735 A1
(43) Pub. Date: Jan. 30, 2014

(54) DEVICE AND METHOD FOR DETERMINING A VOICEMAIL, RING OR ALERT BEHAVIOR OF A TELEPHONE BASED ON DAY AND TIME

(71) Applicant: William Charles Davis, Palmyra, VA (US)

(72) Inventor: William Charles Davis, Palmyra, VA (US)

(21) Appl. No.: 13/560,967

(22) Filed: Jul. 27, 2012

(51) Int. Cl. H04M 1/64

(52) U.S. Cl. 379/88.12

(57) ABSTRACT

A method and apparatus can be used to determine a voicemail, ring and/or alert behavior of a telephone based on day, time and date. By matching the current day and time against a default set or a user input set of ring/alert behaviors, a telephone can be instructed to ring, not ring, refuse a call, flash a light, vibrate or go directly to one of several voicemail messages upon the event of an incoming call. This allows users to program the phone to not disturb them during inconvenient times, such as a baby's nap time, meal time, or the like. In can also prevent early morning and late evening calls while potentially informing the caller that they should call at a more reasonable hour in the future.

### BACKGROUND OF THE INVENTION

The present invention relates to telephone voicemail, ring and alert behavior and more particularly, to a device that determines the voicemail, ring or alert behavior of a telephone based on day and time.

Modern telephones are becoming more and more capable and, as a result, people are becoming more and more connected to one another. While there are benefits to 24/7 connectivity, people are also more exposed than ever to being called at an inconvenient time.

Conventional telephones are designed with the assumption that users want to be alerted to an incoming call, regardless of the time of day or the date. As a result, telemarketers target their calls around family time, often interrupting meals. Sleeping infants are often disturbed by phones that could use more subtle alert mechanisms than a loud ring.

While most phones offer users a mechanism to change the ring and/or alert tones to different settings and volumes, to do this requires user input and action.

As can be seen, there is a need for a device and method to change the voicemail, ring and/or alert behavior of a telephone based on factors such as the day, date and time.

### SUMMARY OF THE INVENTION

In one aspect of the present invention, a time capable central processing unit (CPU) operably coupled to a telephone device, the time capable central processing unit running software operable to perform the steps of detecting an incoming call; and controlling a voicemail, ring or alert behavior on the telephone device based upon a time and a day of the incoming call.

In another aspect of the present invention, a method for controlling the ring behavior of a telephone device comprises receiving an incoming call; determining a time and a day of the incoming call; comparing the time and the day of the incoming call to a voicemail/ring/alert behavior data set; and adjusting the voicemail/ring/alert behavior of the telephone device, wherein the ring/alert behavior data set is one of a pre-programmed default data set and a user-programmed data set.

These and other features, aspects and advantages of the present invention will become better understood with reference to the following drawings, description and claims.

### BRIEF DESCRIPTION OF THE DRAWINGS

FIG. 1 is a perspective view of a telephone having a time and date capable central processing unit (CPU) built thereinto, according to an exemplary embodiment of the present invention;

FIG. 2 is a perspective view of a telephone having an external device with a time and date capable CPU and caller ID, according to an exemplary embodiment of the present invention; and

FIG. 3 is a flow chart describing a method for determining a ring and/or alert behavior of a telephone based on day and time, according to an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method and apparatus for determining a voicemail, ring and/or alert behavior of a telephone based on day, time and date. By matching the current day and time against a default set or a user input set of voicemail/ring/alert behaviors, a telephone can be instructed to ring, not ring, refuse a call, flash a light, vibrate or go directly to one of several voicemail messages upon the event of an incoming call. This allows users to program the phone to not disturb them during inconvenient times, such as a baby's nap time, meal time, or the like. In can also prevent early morning and late evening calls while potentially informing the caller that they should call at a more reasonable hour in the future.

Previously, users of land line telephones had to resort to unplugging their phone or, in some cases, turning off the ringer, in order to not be disturbed. Mobile phones are only slightly more flexible, allowing for silent mode or vibrate to be set. However, both of these methods require a user to remember to make the change, and then to also remember to make the change back to normal, else they could miss calls during days and times where they desire to receive calls.

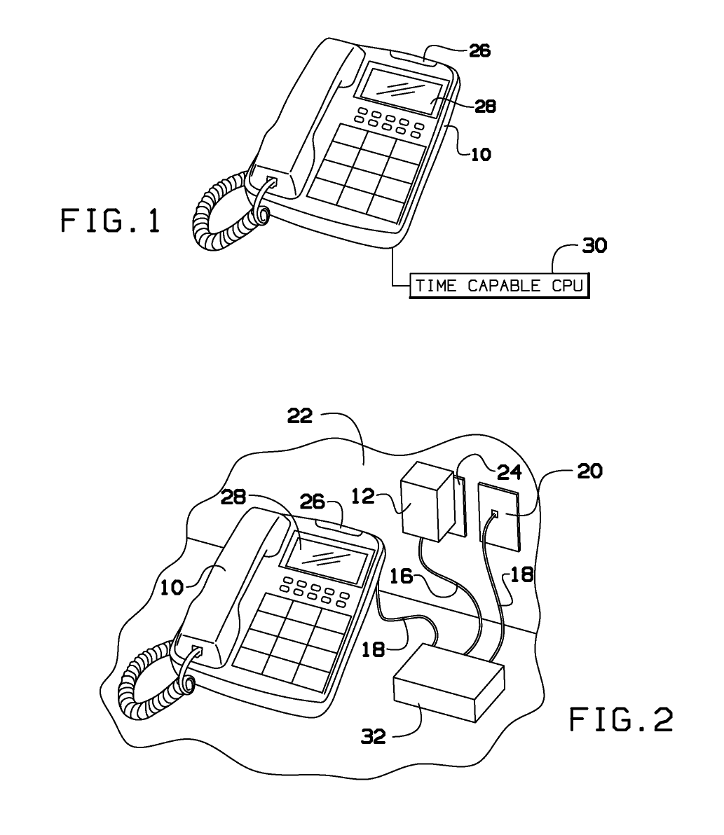

Referring to FIG. 1, a land line telephone 10 can include, for example, a light bar 26 and a display 28. The telephone 10 can also include a built-in time/date capable CPU 30 that can be used to determine a ring and/or alert character depending on the day and time.

A user can program the CPU 30 via various mechanisms. In some embodiments, a user can use buttons and the display 28 included with the telephone 10 to program the CPU 30. In other embodiments, the telephone 10 can be connected with another device, such as a computing device (for example, a tablet computer, a laptop computer, a desktop computer, or the like) via a cable (such as a universal serial bus (USB) cable), wireless network, Bluetooth® or the like. The computing device can include software to allow the user to program the telephone 10 to adjust its voicemail, ring and/or alert characteristics based on time and day. In still other embodiments, the CPU 30 can include a default data set that can be selected to control the ring and/or alert characteristics according to the pre-programmed settings.

Referring to FIG. 2, in some embodiments, an add-on device 32 can be used with the telephone 10 to control the voicemail, ring and/or alert characteristics of the telephone. The add-on device 32 can be installed, for example, in line with a phone cord 18 that is connected to a telephone jack 20 in a wall 20. A power adapter 12 can be used to provide power to the device 32 via a power cord 16.

The device 32 can include a time/date capable CPU that can function similar to the time/date capable CPU 30 described above. The device 32 can receive a signal of an incoming call and determine, based on the programmed settings, whether to allow the call to continue to the telephone and ring.

In both embodiments, subtle alert methods could be selected, such as quiet ring, custom ring tones, vibrate, light flash, or screen flash, send to a particular voicemail, or the like.

In some embodiments, callers can be notified that, if they call during a time in which the user wishes not to be disturbed, that they are calling at an undesirable time and to try back. For example, if the device 32 (or the CPU 30) is programmed to not ring the phone during a baby's nap time from 2 pm through 4 pm each day, Monday through Friday, if someone calls during that time, they can get a message that it is the baby's nap time and to try back after 4 pm.

In some embodiments, other parameters could be considered to further improve the usefulness of the device and method of the present invention. For example, caller ID information can be used and compared against lists of names that should always ring the phone and those that should never ring the phone. This list can control the ring characteristics over the programmed time and/or day settings. Calls with blocked caller ID could be screened and announced to the user.

The CPU 30 and the device 32 (which can include a CPU, memory and like components) can be controlled with a software application that allows the user to program data, such as when to allow the phone to ring, when to use vibrate only, when to use a soft ring, when to flash a light only, and the like. The software can use storage resources on the telephone to maintain the data set of telephone voicemail/ring/alert behaviors, or the present invention can include dedicated storage for the data set.

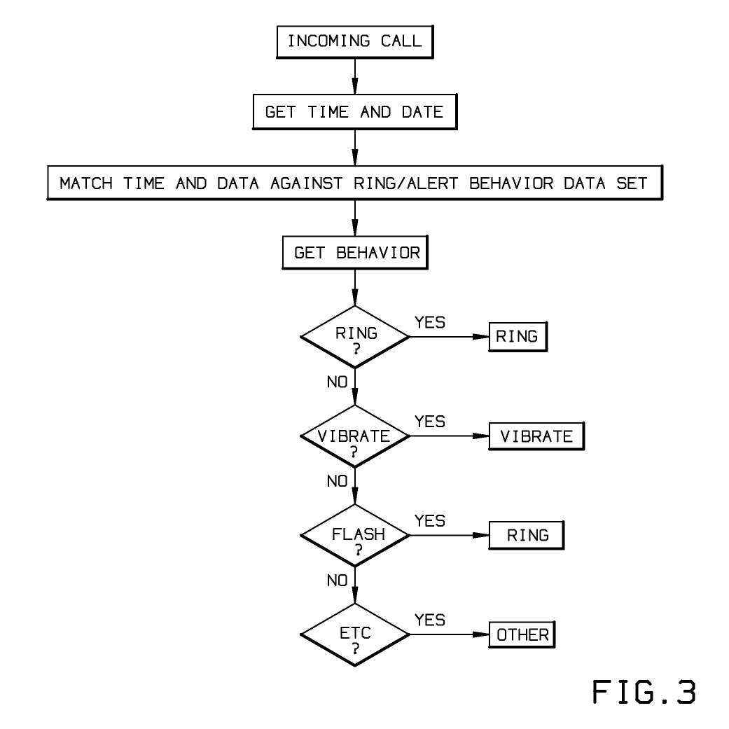

When an incoming call occurs, the software matches the current day and time against the data set to determine the voicemail, ring and/or alert behavior. When the behavior is determined, the software can cause the phone to behave in the appropriate manner. FIG. 3 shows a flowchart describing an exemplary set of steps the software may perform to cause the phone to behave in a user-desired manner.

While the above Figures show a conventional land-line telephone, the present invention could also work with a smart phone via a smart phone application. The application can allow the user to select a ring/alert behavior of the smart phone based on a day and time. The present invention can also work with computer telephony applications with programmable ring/alert behavior. A computer telephony application could be written that uses the method of the present invention to determine what behavior to present on the event of an incoming call.

It should be understood, of course, that the foregoing relates to exemplary embodiments of the invention and that modifications may be made without departing from the spirit and scope of the invention as set forth in the following claims.

What is claimed is:

1. A time capable central processing unit (CPU) operably coupled to a telephone device, the time capable central processing unit running software operable to perform the steps of:
detecting an incoming call; and
controlling a voicemail, ring or alert behavior on the telephone device based upon a time and a day of the incoming call.

2. The time capable CPU of claim 1, wherein the software is operable to further perform the step of obtaining settings from a user to set the ring behavior specifically for certain times and days.

3. The time capable CPU of claim 1, wherein the time capable CPU is integrated into the telephone device.

4. The time capable CPU of claim 1, wherein the time capable CPU is a device external and operably connected to the telephone device.

5. The time capable CPU of claim 1, wherein the voicemail, ring or alert behavior includes at least one of a normal ring, a soft ring, a light flash, a display flash, a vibration, a custom sound, send to voicemail and no ring.

6. The time capable CPU of claim 1, wherein the telephone device is selected from the group consisting of a mobile phone, a smart phone, a land line phone, and computer telephony.

7. A method for controlling the ring behavior of a telephone device, comprising:
receiving an incoming call;
determining a time and a day of the incoming call;
comparing the time and the day of the incoming call to a voicemail/ring/alert behavior data set; and
adjusting the ring/alert behavior of the telephone device, wherein the voicemail/ring/alert behavior data set is one of a pre-programmed default data set and a user-programmed data set.

8. The method of claim 7, further comprising allowing a user to program one or more user-programmed data sets.

9. The method of claim 7, further comprising automatically answering the incoming call with a prerecorded message.

10. The method of claim 7, wherein the ring/alert behavior includes a ring, a vibration, a flash, a soft ring, a custom sound, send to voicemail and no ring.
